(19) United States
(12) Patent Application Publication
(10) Pub. No.: US 2006/0203492 A1
(43) Pub. Date: Sep. 14, 2006

(54) Discharge lamp with reflector

(75) Inventors: Hideyuki Matsumoto, Yokohama (JP); Takayuki Nabeshima, Yokohama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Patent-Treuhand-Gesellschaft fur Elektrische Gluhlampen mbH, Munich (DE)

(21) Appl. No.: 11/372,339

(22) Filed: Mar. 9, 2006

(30) Foreign Application Priority Data
Mar. 14, 2005 (JP) 2005-70360

(51) Int. Cl. F21V 7/00

(52) U.S. Cl. 362/296

(57) ABSTRACT

In order to provide a discharge lamp with reflector in which thermal deterioration is inhibited by the diffusing of the irradiated light that leaks from the glass end part of the sealed part to suppress the rise in temperature of the component parts of the projector arranged to the rear of the lamp, the following means are used:

In the discharge lamp with reflector 1 pertaining to the this invention, which constitutes a discharge lamp with reflector 1 in which a light-emitting tube 2 is housed in the reflector 3 interior and a rear sealed end part 4 of the light-emitting tube 2 is exposed to the rear of the reflector 3, the rear sealed end part 4 of the light-emitting tube 2 is formed as a frosted part 6.

### TECHNICAL FIELD

The invention relates to a discharge lamp with reflector as described in the pre-characterizing part of claim 1. such a lamp is for example employed as a light source for a projector.

### BACKGROUND ART

The light-emitting component of a light-emitting tube of a discharge lamp with reflector is located at the focal point of the bowl-shaped reflector of, for example, a spherical, elliptical or parabolic surface, see for example Japanese Unexamined Patent Application No. 2002-319310. The irradiated light reflected by a reflector film coated on the interior surface of the reflector is irradiated to the front of the lamp. This irradiated light falls incident on an optical system provided in front of the lamp.

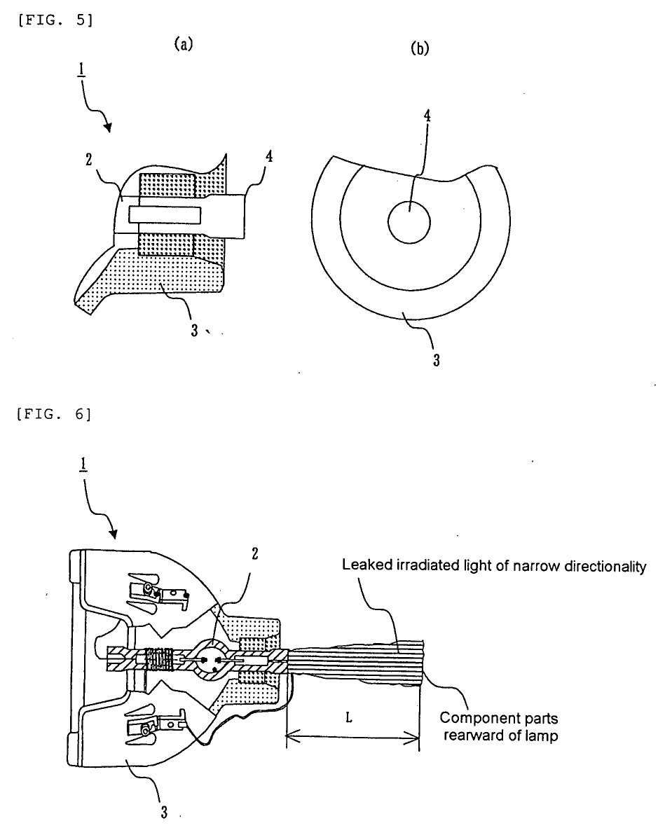

On the other hand, as shown in FIG. 5, so-called leakage light is irradiated rearward from a rear sealed glass end part 4—which protrudes from the rear of a reflector 3 of a discharge lamp with reflector 1—of a light-emitting tube 2.

As shown in FIG. 6, the irradiated light that leaks from the rear sealed glass end part 4 of the light-emitting tube 2 contains thermal energy and is irradiated with narrow directionality.

### DISCLOSURE OF THE INVENTION

It is an object of the present invention to create a discharge lamp as described in the pre-characterizing part of claim 1 which avoids the disadvantages of the prior art. A problem inherent to the discharge lamp with reflectors of the prior art pertains to the thermal deterioration of the component parts within the projector arranged to the rear of the lamp resulting from the irradiation of the light leaked from the rear sealed glass end part 4 of the light-emitting tube 2 that contains thermal energy and is irradiated with narrow directionality.

An object of the invention, which is designed to resolve this problem, is to provide a discharge lamp with reflector in which thermal deterioration is inhibited by the diffusing of the irradiated light that leaks from the glass end part of the sealed part to suppress the rise in temperature of the component parts of the projector arranged to the rear of the lamp.

This object is achieved by the characterizing features of claim 1. Particularly advantageous refinements will be found in the dependent claims. In the discharge lamp with reflector pertaining to this invention, which constitutes a discharge lamp in which a light-emitting tube is housed in the reflector interior and the rear sealed end part of the light-emitting tube is exposed to the rear of the reflector, the rear sealed end part of the light-emitting tube is formed as a frosted part.

In the discharge lamp with reflector pertaining to the invention of the configuration described above, thermal deterioration is inhibited by the diffusing of the irradiated light that leaks from the glass end part of the sealed part to suppress the rise in temperature of the component parts of the projector arranged to the rear of the lamp.

In detail the light-emitting tube is housed in the reflector interior, whereby the tube is axially aligned in the reflector. The tube having a first and second end, the first end directing to a reflector opening and the second end directing to a neck of the reflector. A rear part of the second end is frosted. Preferably this rear part, which is frosted, is at least the surface of the second end which extends in a plane perpendicular to the lamp axis. The frosted part may also include further surfaces which are in the neighborhood of this rear part.

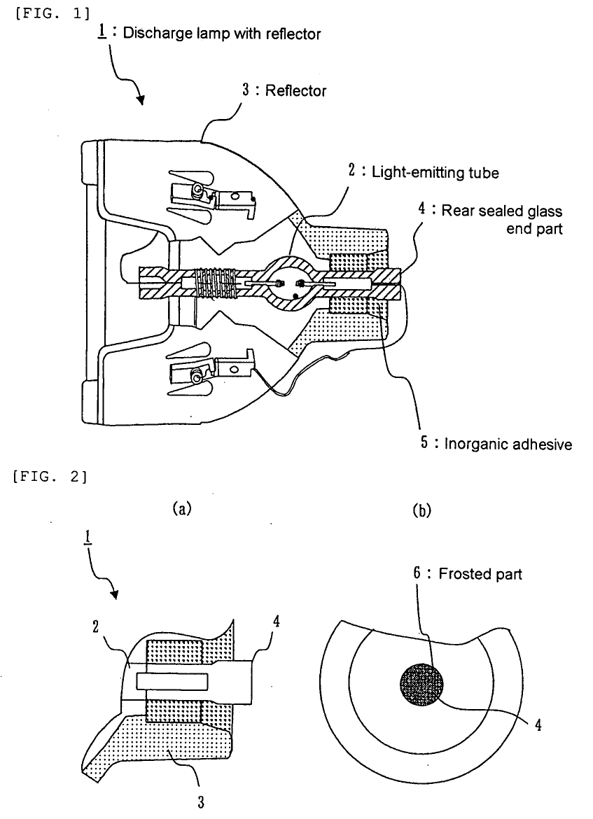

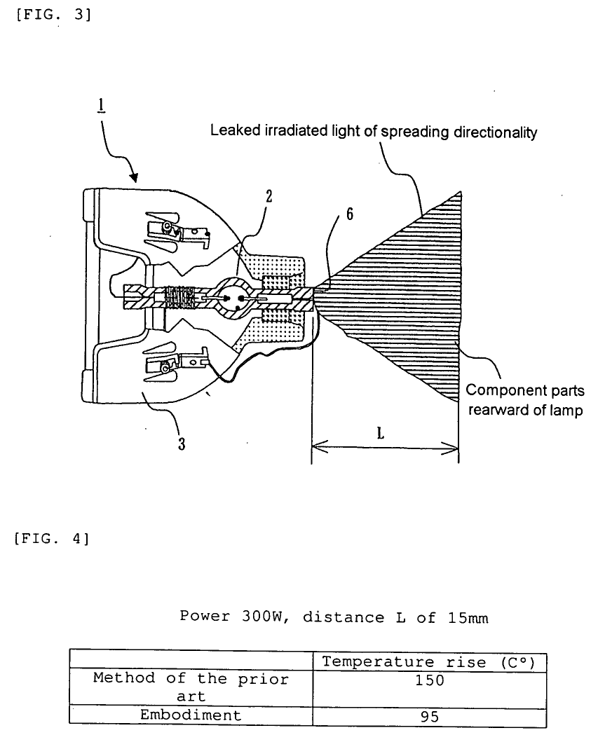

### BRIEF DESCRIPTION OF THE DRAWINGS

[FIG. 1] is a cut-away cross-sectional view of a discharge lamp with reflector of embodiment 1 of the invention;

[FIG. 2] (a) is a main part front view and (b) is a main part front view of the discharge lamp with reflector of embodiment 1 of the invention;

[FIG. 3] is a diagram that shows the irradiated light leaked from the rear part of the discharge lamp with reflector of embodiment 1;

[FIG. 4] is a diagram of the test results obtained in a comparison of temperature rise of the component parts to the rear of the projector between a device of the prior art and the discharge lamp with reflector of embodiment 1;

[FIG. 5] (a) is a main part front view and (b) is a main part front view of a discharge lamp with reflector of the prior art; and

[FIG. 6] is a diagram showing the irradiated light leaked from the rear of a discharge lamp with reflector of the prior art.

### BEST MODE FOR CARRYING OUT THE INVENTION

FIGS. 1 to 4 represent diagrams of an embodiment mode 1: FIG. 1 is a cut-away side view of part of a discharge lamp with reflector, FIG. 2 (a) is a main part side view and (b) is a main part front view of a discharge lamp with reflector, FIG. 3 is a diagram showing the irradiated light leaked from the rear part of the discharge lamp with reflector, and FIG. 4 is a diagram of the test results obtained from a comparison with a discharge lamp with reflector of the prior art of the temperature rise of the component parts of the projector to the rear of the discharge lamp. As shown in FIG. 1, in a discharge lamp with reflector 1, a light-emitting tube 2 is housed in the reflector 3 interior, the light-emitting component of the light-emitting tube 2 is located at the focal point of the reflector 3, and the irradiated light is reflected by a reflector film coated on the interior surface of the reflector 3 and is irradiated to the front of the lamp. The irradiated light falls incident on an optical system provided in front of the lamp.

The light-emitting tube 2, which is sealed at its two end parts, is fixed to the reflector 3 in the vicinity of the rear sealed part using an inorganic adhesive 5. A rear sealed glass end part 4 protrudes rearward of the reflector 3 and is exposed to the exterior.

As shown in FIG. 2, the rear sealed glass end part 4 constitutes a frosted part 6 on which a frosting treatment has been administered.

The term frosting treatment refers to a treatment that involves the use of either a coarse abrasive or a fine powder abrasive and the blowing of the abrasive using pressured air while the term frosted refers to the formation of “frost” and implies the formation of a white mist, and an example method of said treatment involves the formation of glass or similar as a misted glass.

FIG. 3 shows a discharge lamp with reflector 1 comprising a glass end part 4 on which this frosting treatment has been administered in which the directionality of the leaked irradiated light from the rear sealed glass end part 4 has been caused to spread and diffuse. This diffusion of the irradiated light is thought to suppress the rise in temperature of the component parts of the projector arranged to the rear of the discharge lamp with reflector 1.

The temperature rise of the component parts of the projector arranged to the rear of the discharge lamp with reflector 1 was compared with a device of the prior art on which no frosting treatment has been administered and irradiation occurs with narrow directionality.

FIG. 4 shows the test results resulting from this comparison. The measurement of the rise in temperature of the component parts of the projector was taken at power 300 W and a distance L from the rear sealed glass end part 4 to the component parts within the projector of 15 mm. As is clear from this diagram, the administering of a frosting treatment on the rear sealed glass end part 4 results in a significant lowering of a rise in temperature of the component parts within the projector.

As is described above, a rise in temperature of the component parts within the projector can be significantly reduced by the administering of a frosting treatment on the rear sealed glass end part 4 of the light-emitting tube 2 of the discharge lamp with reflector 1 to diffuse the irradiated light of narrow orientation.

[Explanation of Symbols]

1 Discharge lamp with reflector, 2 Light-emitting tube, 3 Reflector, 4 Rear sealed glass end part, 5 Inorganic adhesive, 6 Frosted part.

1. Discharge lamp with reflector in which a light-emitting tube is housed in the reflector interior, whereby the tube is axially aligned in the reflector, said tube having a first and second end, the first end directing to a reflector opening and the second end directing to a neck of the reflector, characterized in that a rear part of the second end is frosted.

2. Lamp in accordance with claim 1, characterized in that the frosted part is at least the surface of the second end which extends in a plane perpendicular to the lamp axis.
